(19) United States
(12) Patent Application Publication
(10) Pub. No.: US 2024/0109079 A1
(43) Pub. Date: Apr. 4, 2024

(54) BATCH CENTRIFUGAL CONCENTRATOR

(71) Applicant: GEKKO SYSTEMS PTY LTD, Victoria (AU)

(72) Inventor: Alexander Hamilton LEWIS-GRAY, Victoria (AU)

(21) Appl. No.: 18/275,003

(22) PCT Filed: Jan. 28, 2022
(86) PCT No.: PCT/AU2022/050039

§ 371 Date: Jul. 29, 2023

(30) Foreign Application Priority Data
Jan. 29, 2021 (AU) 2021900196

(51) Int. Cl. B04B 1/00; B04B 7/12

(52) U.S. Cl. CPC B04B 1/00; B04B 7/12

(57) ABSTRACT

In one form, the present invention is a Batch Centrifugal Concentrator adapted to mitigate the adverse effects associated with dirty feedwater including a rotary bowl having means to clear solid particulate matter in a high velocity flow stream. In another form, the present invention is a seal assembly adapted for use with a batch centrifugal concentrator. The seal assembly including a non-rotating lower portion and a rotating upper portion. The non-rotating lower portion includes a water in/out port, and the rotating upper portion includes a water in/out port. Each port is interconnected by a conduit that is adapted to enable fluid to flow into, through and out of the seal assembly. A gap is provided between the said lower and upper portions. The stationary portion includes an air inlet port that is adapted to create and maintain a zone of positive pressure within said gap.

### FIELD OF THE INVENTION

This invention relates to Batch Centrifugal Concentrators, and in particular it relates to the bowl component used therein.

### BACKGROUND OF THE INVENTION

Batch Centrifugal Concentrators (BCC) are a class of major equipment used mainly in minerals processing operations. They are often used in remote locations. Due to the nature of their operation, they are continuously subjected to large impact loads and abrasive slurry flows. The major component of any BCC is the bowl. The inner sidewall of the bowl is subjected to a very mechanically hostile environment during its operation, and therefore the bowl needs to be robust and durable so that the BCC has a satisfactory operational life between maintenance and refurbishment operations where the equipment is required to be taken out of service. This typically has a significant impact on mine site operational efficiency and profitability. Typically, BCCs are large bulky apparatus, with a correspondingly large unitary bowl.

BCCs operate by creating zones upon the inner sidewall of the bowl that act as localised fluidized bed regions. They do this by injecting a fluid, typically water, through a plurality of outflow ports strategically located around the periphery of the inner wall of the bowl that are adapted to inject fluid into the bowl. Because many mineral processing operations operate in remote locations close to mine sites, they are often subject to feedwater that is contaminated with particulate matter. The feedwater often includes solids, such as dirt and/or silicates, and dissolved solids that may precipitate out of solution and block the plurality of relatively small water injection ports arrayed about the inner wall of the bowl. The blocking of these ports increases the frequency that the BCC needs to be taken out of service for a maintenance as it degrades the fluidized bed effect within the BCC bowl.

Further to this, the feedwater is fed into the BCC system typically through a rotary junction. Within that junction is a seal. Again, particulates such as silicates, and/or dirt, entrained in the feedwater may contaminate the mechanical seal and cause it to fail prematurely, mainly through abrasive wear and tear. Again, this increases the frequency of downtime due to maintenance operations. Replacing failed seals takes time, and the cost of replacement seals are expensive. Often the entire rotary junction is replaced, adding even more cost to the operation.

The net effect of these common modes of failure caused by dirty feedwater is a less efficient minerals processing operation. Higher capital costs in plant and ancillary parts and maintenance services as more BCCs are required to ensure the minerals processing plant has sufficient redundancy so that the frequent “off lining” of a particular BCC does not adversely impact production at the plant.

It is therefore an objective of the present invention, to produce a BCC with a bowl that ameliorates at least some of the aforementioned problems.

### DISCLOSURE OF THE INVENTION

Accordingly, in one form, the present invention is a Batch Centrifugal Concentrator adapted to mitigate the adverse effects associated with dirty feedwater including a rotary bowl having means to clear solid particulate matter in a high velocity flow stream.

Preferably, the bowl includes an inner portion and an outer portion. The outer portion includes at least one feedwater inlet port.

Preferably, the bowl includes at least one fluid flow channel that extends substantially directly radially outwardly from the centre of the bowl and substantially radially up the side of the bowl. The fluid flow channel is fluidly connected to the at least one feedwater inlet port so that fluid flows through the fluid flow channel.

Preferably, the at least one fluid flow channel is adapted to permit high velocity fluid flow through it.

Preferably, the high velocity fluid flowrate is controlled by varying the dimensions of the at least one fluid flow channel along a substantial portion of the sidewall of the bowl.

Preferably, the at least one fluid flow channel is fluidly connected to a solids relief port located near the top of the sidewall of the bowl so that the high velocity fluid flow exits the at least one fluid flow channel through it.

Preferably, the solids relief port is fluidly connected to a solids relief hole whereat solid material, such as silicates, are forced out of the bowl.

Preferably, the inner portion of the bowl includes a plurality of fluid injection ports adapted to form a localised fluidised bed at least in the vicinity of each particular port, and wherein each fluid injection port is fluidly connected to a respective at least one fluid flow channel.

Optionally, the bowl is assembled from a plurality of bowl segments. Each bowl segment is adapted to fit together in a preferred arrangement so that when so arranged, the segments form the segmented bowl assembly, and at least some of the segments include channels and ports so that when the bowl is assembled, the segmented bowl assembly includes at least one fluid inlet port and at least one fluid flow channel, and a respective solids relief port and a respective solids relief hole.

Preferably, the bowl segments include means that enable adjacent segments to be interconnectable.

Optionally, at least one of the bowl segments is able to be 3D printed.

In another form, the present invention is a seal assembly adapted for use with a batch centrifugal concentrator. The seal assembly including a non-rotating lower portion and a rotating upper portion. The non-rotating lower portion includes a water in/out port, and the rotating upper portion includes a water in/out port. Each port is interconnected by a conduit that is adapted to enable fluid to flow into, through and out of the seal assembly. A gap is provided between the said lower and upper portions. The stationary portion includes an air inlet port that is adapted to create and maintain a zone of positive pressure within said gap.

Preferably, the zone of positive pressure is maintained during at least the operation of the batch centrifugal concentrator to thereby mitigate the ingress and accumulation of debris on the sealing surfaces within the seal assembly and thereby greatly increase the mean time between failures for the seal assembly.

Preferably, an air distributor is included and provides the incoming flow of air to maintain the positive pressure in the air gap.

Preferably, a lip seal is included to substantially entrap the air within the zone of positive pressure.

### BRIEF DESCRIPTION OF THE DRAWINGS

FIG. 1 (a) and (b) are isometric views of a typical bowl segment, used in combination with other bowl segments to form the bowl inside a batch centrifugal concentrator. The views show the flow channels associated with the segment in accordance with the present invention.

FIG. 2 is an isometric view of a prior art seal, of the type that suffers failure due to the abrasive action of debris or dissolved solids precipitating out of the solution, used in a typical batch centrifugal concentrator.

FIG. 3 is an isometric view of a seal used in accordance with a preferred embodiment of the present invention.

### DESCRIPTION OF THE PREFERRED EMBODIMENTS

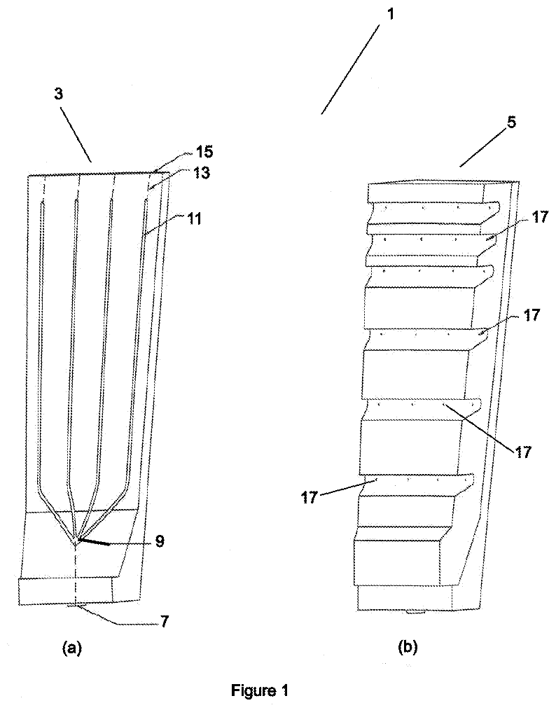

Turning firstly to FIG. 1, we are shown one form of the present invention where a preferred embodiment of the segment (1) is shown. The segment (1) has an outer segment portion (3) (seen in FIG. 1(a)) and an inner segment portion (5) (seen in FIG. 1(b)). In this preferred embodiment, the segment (1) is constructed from sub-parts (a) and (b). Optionally, the segment is capable of being produced by 3D printing. Preferably, the outer segment portion (3), includes a dirty water inlet port (7) that is connected to the internal water port (9) via a fluid channel. The internal water port (9) is connected to a plurality of high velocity water channels (11). These are oriented nearly parallel to one another with a slight radial outward angle. The depth of each channel (11) changes along the height of the sidewall of the outer segment portion (3) in order to maintain high velocity flow as the water is injected into the outer segment portion (3). The outer segment portion (3) includes an internal solids relief port (13) at the top of each channel (11). Each solids relief port (13) is connected to a respective solids relief hole (15) at the top of the outer segment portion (3).

Turning to FIG. 1(b), where we are shown the inner segment portion (3), we can see a plurality of water injection holes (17). Each of the holes (17) are in fluid flow contact with one of the plurality of high velocity water galleries (11). In this preferred embodiment, each segment (1) has fewer and larger diameter water injection holes (17) when compared to prior art segments like those disclosed in WO2019144179.

The advantage of the present invention is that centrifugal force continuously forces any solids or precipitate up each channel (II) and out through the solids relief port (13) and the solids relief hole (15) so that they therefore self-empty. There are no volumes of water located in the system that would allow solids to settle out into and put the bowl out of balance.

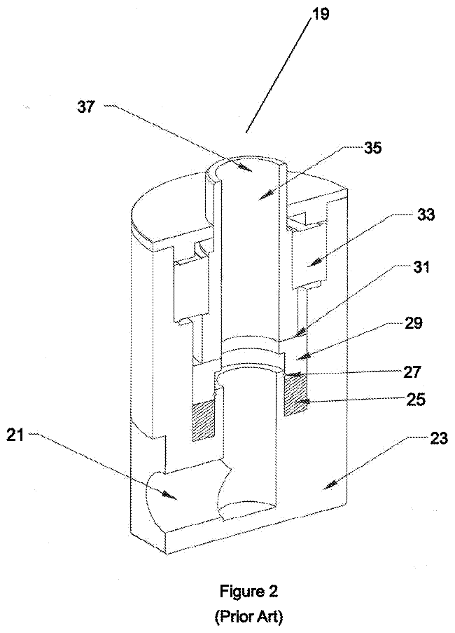

Turning to FIG. 2, we can see an isometric view of a mechanical seal assembly (19) that is typically used in the prior art. The seal (19) is part of the rotary union. The mechanical seal assembly (19) includes a bottom water in/out port (21) integrated into a stationary portion (23) of the seal assembly (19). The seal uses a spring (25) to maintain engagement of the non-rotating sliding seal (27) and sliding carrier (29) against the ceramic face seal (31). The bearing (33) enables the upper portion (35) to rotate. Feedwater flows through the top in/out flow channel (37).

There has been a decades long problem surrounding conventional sealing techniques. Due to the dirty feedwater typically available in remote sites where mineral processing is undertaken, the feedwater typically has dissolved solids and debris entrained in the water flow. Seals are typically spinning in a centrifuge machine. Any solid matter, such as silicates, entrained in the waterflow, often settle on the mechanical seal assembly. Another problem is associated with dissolved solids precipitating out of solution. These solids are often highly abrasive and quickly destroy the mechanical seal. This leads to more frequent maintenance, and a less efficient and profitable mineral processing plant. Seals are expensive to supply and time consuming to replace in a BCC. Leaking seals are a major problem. There is at least an hour of downtime for the BCC to have a seal replaced. Often the entire rotary union is replaced, leading to even more expense in sourcing the parts, storing them until needed and the labour time associated with replacing the rotary union. Additionally, more capital investment in plant and materials is also required to ensure the necessary redundancy within the plant so that a BCC can be more regularly taken offline for maintenance without affecting the overall operation of the minerals processing plant.

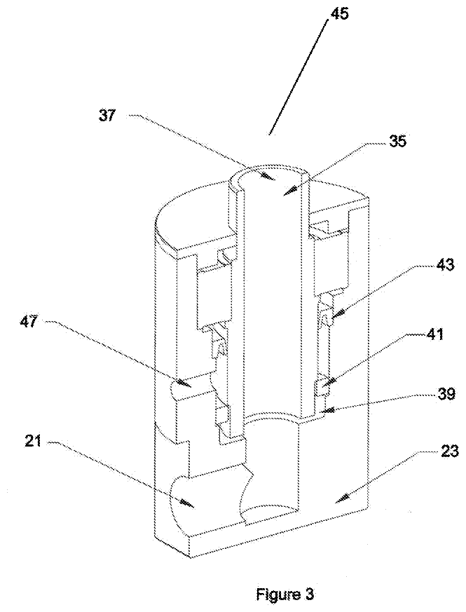

Turning to FIG. 3, we are shown a preferred embodiment of a seal (45) used in accordance with the present invention. This embodiment has a number of significant improvements over the prior art shown in FIG. 2. Just like with the mechanical seal assembly (19), the seal (45) of the present invention has a stationary lower portion (23) and a rotating upper portion (35). A lower water in/out port (21) is located in the lower stationary portion (23), and an upper water in/out port (37) is located in the rotating upper portion (35). The sealing means is provided by a zone of positive air pressure created in the gap (39) via air distributor (41) and the lip seal (43). The air supply to maintain the zone of positive pressure within the seal is supplied through air inlet port (47). The zone of positive pressure mitigates the accumulation of debris on the sealing surfaces and greatly enhances the mean time between failures for the seal assembly (45). This enables the BCC to remain in service for longer periods with less frequent downtimes. This reduces the need for as much redundancy and therefore reduces the capital outlay in plant. The net effect is that the mineral processing plant is therefore more efficient and profitable when compared to the prior art. The lip seal (43) stops the air leaking upwardly and eliminates the need for grease.

While the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A Batch Centrifugal Concentrator adapted to mitigate the adverse effects associated with dirty feedwater including a rotary bowl having means to clear solid particulate matter in a high velocity flow stream.

2. The Batch Centrifugal Concentrator as claimed in claim 1 wherein the bowl includes an inner portion and an outer portion, and wherein the outer portion includes at least one feedwater inlet port.

3. The Batch Centrifugal Concentrator as defined in claim 2 wherein the bowl includes at least one fluid flow channel that extends substantially directly radially outwardly from the centre of the bowl and substantially radially up the side of the bowl, and wherein the fluid flow channel is fluidly connected to the at least one feedwater inlet port so that fluid flows through the fluid flow channel.

4. The Batch Centrifugal Concentrator as defined in claim 3 wherein the at least one fluid flow channel is adapted to permit high velocity fluid flow through it.

5. The Batch Centrifugal Concentrator as defined in claim 4 wherein the high velocity fluid flowrate is controlled by varying the dimensions of the at least one fluid flow channel along a substantial portion of the sidewall of the bowl.

6. The Batch Centrifugal Concentrator as defined in claim 5 wherein the at least one fluid flow channel is fluidly connected to a solids relief port located near the top of the sidewall of the bowl so that the high velocity fluid flow exits the at least one fluid flow channel through it.

7. The Batch Centrifugal Concentrator as defined in claim 6 wherein the solids relief port is fluidly connected to a solids relief hole whereat solid material, such as silicates, are forced out of the bowl.

8. The Batch Centrifugal Concentrator as defined in claim 7 wherein the inner portion of the bowl includes a plurality of fluid injection ports adapted to form a localised fluidised bed at least in the vicinity of each particular port, and wherein each fluid injection port is fluidly connected to a respective at least one fluid flow channel.

9. The Batch Centrifugal Concentrator as defined in claim 8 wherein the bowl is assembled from a plurality of bowl segments, and wherein each bowl segment is adapted to fit together in a preferred arrangement so that when so arranged, the segments form the segmented bowl assembly, and at least some of the segments include channels and ports so that when the bowl is assembled, the segmented bowl assembly includes at least one fluid inlet port and at least one fluid flow channel, and a respective solids relief port and a respective solids relief hole.

10. The Batch Centrifugal Concentrator as defined in claim 9 wherein the bowl segments include means that enable adjacent segments to be interconnectable.

11. The Batch Centrifugal Concentrator as defined in claim 10 wherein at least one of the bowl segments is adapted to be 3D printed.

12. A seal assembly adapted for use with a batch centrifugal concentrator, said seal including a non-rotating lower portion and a rotating upper portion, wherein said non-rotating lower portion includes a water in/out port, and said rotating upper portion includes a water in/out port and wherein each port is interconnected by a conduit that is adapted to enable fluid to flow into, through and out of the seal assembly, and wherein a gap is provided between the said lower and upper portions, and wherein the stationary portion includes an air inlet port that is adapted to create and maintain a zone of positive pressure within said gap.

13. The seal assembly as defined in claim 12 wherein the zone of positive pressure is maintained during at least the operation of the batch centrifugal concentrator to thereby mitigate the ingress and accumulation of debris on the sealing surfaces and thereby greatly increase the mean time between failures for the seal assembly.

14. The Batch Centrifugal Concentrator as defined in claim 13 wherein an air distributor is included and provides the incoming flow of air to maintain the positive pressure in the air gap.

15. The Batch Centrifugal Concentrator as defined in claim 14 wherein a lip seal is included to substantially entrap the air within the zone of positive pressure.
